(19) United States
(12) Patent Application Publication
(10) Pub. No.: US 2008/0304745 A1
(43) Pub. Date: Dec. 11, 2008

(54) IMAGE DISPLAY APPARATUS, IMAGE DISPLAY METHOD, AND RECORDING MEDIUM CONTAINING AN IMAGE-DISPLAY-METHOD PROGRAM

(75) Inventor: Hiroe Honma, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 12/133,037

(22) Filed: Jun. 4, 2008

(30) Foreign Application Priority Data
Jun. 5, 2007 (JP) 2007-148774

(51) Int. Cl. G06K 9/34

(52) U.S. Cl. 382/173

(57) ABSTRACT

An image display apparatus includes a main portion detecting unit configured to perform detection of a main portion of at least one still image from the still image, a cutout unit configured to cut out the main portion from the still image on the basis of a result of the detection by the main portion detecting unit, and a display unit configured to display at least one main portion image based on the main portion cut out by the cutout unit.

### CROSS REFERENCES TO RELATED APPLICATIONS

The present invention contains subject matter related to Japanese Patent Application JP 2007-148774 filed in the Japanese Patent Office on Jun. 5, 2007, the entire contents of which are incorporated herein by reference.

### BACKGROUND OF THE INVENTION

1. Field of the Invention

The present invention relates to an image display apparatus, an image display method, and a recording medium containing an image-display-method program, and is applicable to, for example, a terminal apparatus for printing photographs. The present invention makes it possible to easily and reliably confirm an image being out of focus or the like by detecting and displaying a main portion of a still image.

2. Description of the Related Art

In recent years, in large photo shops, convenience stores, etc., terminal apparatuses for printing photographs taken with electronic still cameras have been installed. A terminal apparatus of the above type prints photographs in such a manner that a user operates the apparatus. By loading a recording medium, such as a memory card containing still images as image pickup data, into the apparatus, various menus are displayed on a display unit of the apparatus. By selecting a menu, the still images contained in the recording medium are displayed as a list of thumbnails. In addition, with the list of thumbnails, by setting images to be printed, a print size, the number of copies to be printed, etc., and by directing printing, the set images to be printed are printed.

The terminal apparatus has a preview function. The terminal apparatus can display a user-selected thumbnail on the basis of the original image, and enables the user to confirm an abnormality such as an image being out of focus before printing.

Regarding an image pickup apparatus, for example, Japanese Unexamined Patent Application Publication No. 2005-295476 discloses a technique concerning display of a list of thumbnails. In the technique disclosed in Japanese Unexamined Patent Application Publication No. 2005-295476, by using a displayed list of thumbnails, a selected thumbnail to be confirmed and a selected portion (of the thumbnail) to be confirmed are received. The selected portion of the selected thumbnail is displayed on the basis of the original image, whereby an abnormality such as an image being out of focus can be confirmed.

However, in a case where, using a terminal apparatus installed in a photo shop or the like, an image being out of focus or the like is confirmed on the basis of an original image by selecting a thumbnail each time, a complicated operation needs to be performed.

### SUMMARY OF THE INVENTION

The present invention has been made in view of the foregoing circumstances. It is desirable to provide an image display apparatus and an image display method that easily and reliably confirm an abnormality such as an image being out of focus, and a recording medium containing a program of the image display method.

According to an embodiment of the present invention, there is provided an image display apparatus including main portion detecting means for performing detection of a main portion of at least one still image from the still image, cutout means for cutting out the main portion from the still image on the basis of a result of the detection by the main portion detecting means, and display means for displaying at least one main portion image based on the main portion cut out by the cutout means.

According to another embodiment of the present invention, there is provided an image display method for displaying at least one still image. The image display method includes the steps of performing detection of a main portion of the still image from the still image, cutting out the main portion from the still image on the basis of a result of the detection, and displaying at least one main portion image based on the cut-out main portion.

According to another embodiment of the present invention, there is provided a recording medium containing a program of an image display method for displaying at least one still image. The image display method includes the steps of performing detection of a main portion of the still image from the still image, cutting out the main portion from the still image on the basis of a result of the detection, and displaying at least one main portion image based on the cut-out main portion.

According to the embodiments of the present invention, a main portion of a still image can be confirmed without designating a portion to be displayed each time for each original image. Therefore, an abnormality, such as an image being out of focus, can be easily and reliably confirmed.

According to the embodiments of the present invention, an abnormality, such as an image being out of focus, can be easily and reliably confirmed.

### BRIEF DESCRIPTION OF THE DRAWINGS

FIG. 1 is a flowchart showing a process of a central processing unit in an image printing apparatus according to an embodiment of the present invention;

FIG. 2 is a perspective view showing the image printing apparatus according to the embodiment;

FIG. 3 is a block diagram showing the image printing apparatus shown in FIG. 2;

FIG. 4 is a plan view showing an insertion guidance screen of the image printing apparatus shown in FIG. 2;

FIG. 5 is a plan view showing a menu screen of the image printing apparatus shown in FIG. 2;

FIG. 6 is a plan view showing a thumbnail list screen of the image printing apparatus shown in FIG. 2;

FIG. 7 is a plan view showing a displayed preview screen of the image printing apparatus shown in FIG. 2;

FIG. 8 is a plan view showing a main portion list screen of the image printing apparatus shown in FIG. 2;

FIGS. 9A and 9B are plan views for use in illustrating the process shown in FIG. 1;

FIGS. 10A and 10B are plan views for use in illustrating a process in a case where a plurality of faces have been detected;

FIGS. 11A and 11B are plan views for use in illustrating a process for an example different from that shown in FIGS. 10A and 10B;

FIG. 12 is a flowchart continued from FIG. 1;

FIGS. 13A and 13B are plan views for use in illustrating detection of importance;

FIGS. 14A and 14B are plan views for use in illustrating processing in a case where a plurality of regions having high importance have been detected; and

FIGS. 15A and 15B are plan views for use in illustrating processing for an example different from that shown in FIGS. 14A and 14B.

### DESCRIPTION OF THE PREFERRED EMBODIMENTS

Embodiments of the present invention will be described below with reference to the accompanying drawings.

### First Embodiment

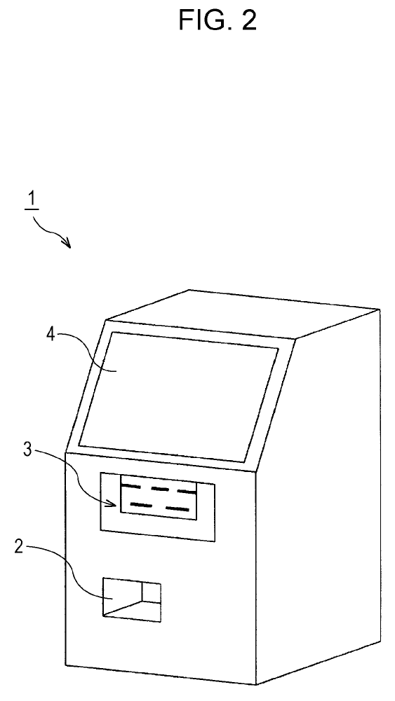

FIG. 2 is a perspective showing an image printing apparatus 1 according to a first embodiment of the present invention. The image printing apparatus 1 is a terminal apparatus for printing photographs taken with electronic still cameras. The image printing apparatus 1 is installed in a store and prints still images recorded on a recording medium such as a memory card.

The entirety of the image printing apparatus 1 is formed to be vertically long and rectangular. At a front face of the image printing apparatus 1, an ejection slot 2 for ejecting photographs as printed results is provided. Above the ejection slot 2, a recording-medium-insertion-slot unit 3 from which various recording media are loaded is provided. In addition, the image printing apparatus 1 has an image display section 4 on which a touch panel 14 is disposed. The image display section 4 is provided above the insertion-slot unit 3. The image printing apparatus 1 receives a user's operation by using the touch panel 14 to detect selection on various menus displayed on the image display section 4.

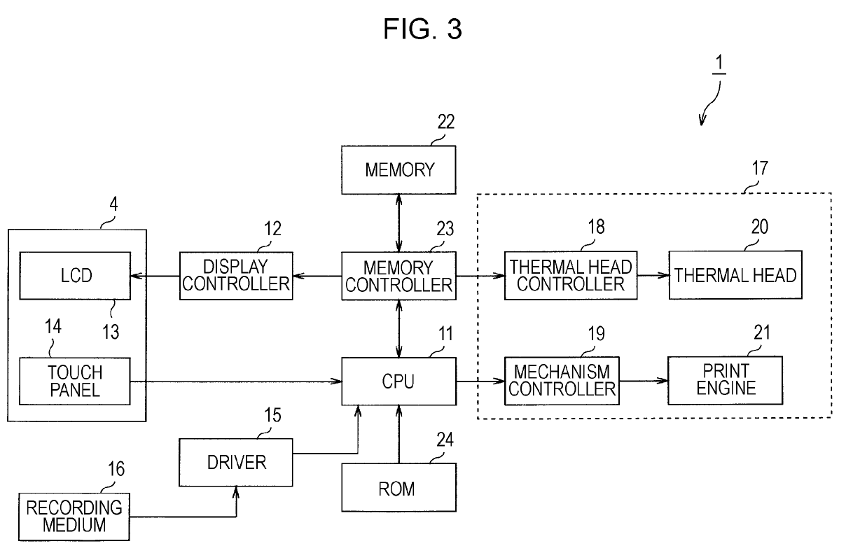

FIG. 3 is a block diagram showing the image printing apparatus 1. In the image printing apparatus 1, under the control of a central processing unit (CPU) 11, the image display section 4 uses a display controller 12 to drive a liquid crystal panel (LCD) 13, whereby various menus, etc., necessary for processing of the image printing apparatus 1 are displayed.

The touch panel 14 is disposed on a display face of the LCD 13, and reports a menu selection of the user to the CPU 11. Under the control of the CPU 11, a driver 15 acquires image data or the like from a recording medium 16 inserted into an insertion slot of the insertion-slot unit 3.

Under the control of the CPU 11, a printing unit 17 prints a still image on predetermined paper, and ejects the printed paper from the ejection slot 2. In the first embodiment, the printing unit 17 prints the still image by using a thermal controller 18 and a mechanism controller 19 to respectively drive a thermal head 20 and a print engine 21. Under the control of a memory controller 23, a memory 22 temporarily stores and outputs image data that is printed by the printing unit 17 and image data of various types that is displayed by the image display section 4.

The CPU 11 controls an operation of the entirety of the image printing apparatus 1, and controls operations of portions of the image printing apparatus 1 by executing a program recorded in a read-only memory (ROM) 24. In the first embodiment, a program for the CPU 11 is provided in such a form that it is installed beforehand. Instead, the program may be provided in such a form that it is recorded on a recording medium such as an optical disc, a magnetic disk, or a memory card. In addition, the program may be provided in such a form that it is downloaded via the Internet.

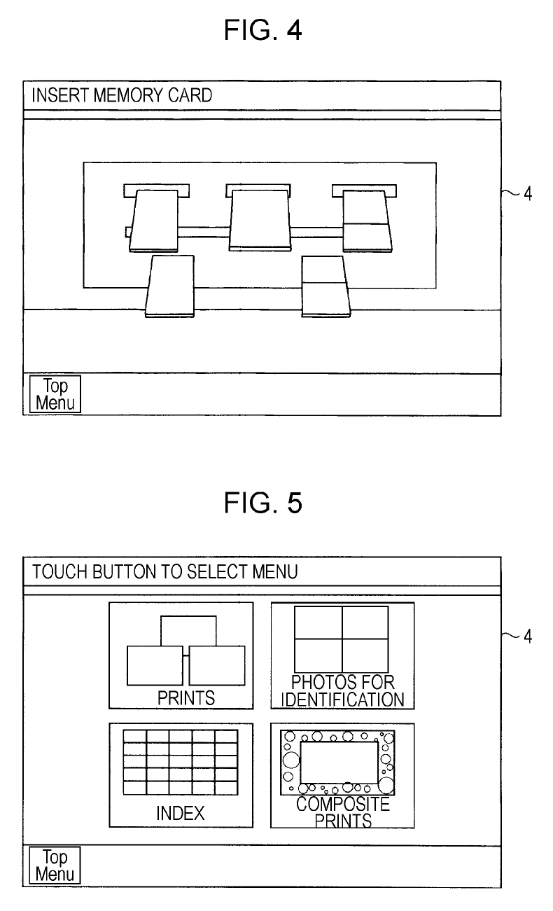

The CPU 11 displays a predetermined top menu screen in an initial state by executing the program. A predetermined menu is selected on the top menu screen, whereby the CPU 11 displays the insertion guidance screen shown in FIG. 4. The displayed insertion guidance screen urges the user to load the recording medium 16. On the insertion guidance screen, a message that urges the user to load the recording medium 16 is displayed at the top, and the item “Top Menu” that directs display of the top menu screen is displayed on the left side at the bottom. In addition, an image showing that types of the recording medium 16 are loaded into insertion slots of the insertion-slot unit 3 is displayed. When selection of the item “Top Menu” is detected on the insertion guidance screen, the CPU 11 switches the displayed screen to the top menu screen.

Alternatively, when insertion of the recording medium 16 into any insertion slot of the insertion-slot unit 3 is detected via the driver 15, the CPU 11 displays the menu screen shown in FIG. 5. The displayed menu screen is used to select a process that is performed by the image printing apparatus 1. On the menu screen, a message that urges the user to perform an operation is displayed at the top, and selectable menus of types are displayed below the message. Among the selectable menus, the menu entitled “PRINTS” is used to print still images one by one in a service size or the like, the still images being recorded on the recording medium 16. The menu entitled “PHOTOS FOR IDENTIFICATION” is used to print photographs for identification. The menu entitled “INDEX” is used to perform printing in a contact sheet form for use in an index. The menu entitled “COMPOSITE PRINTS” is used to perform printing in a form in which, for example, a frame or the like is disposed by image composition. Below the selectable menus, the item “Top Menu” that directs display of the top menu screen is displayed at the bottom.

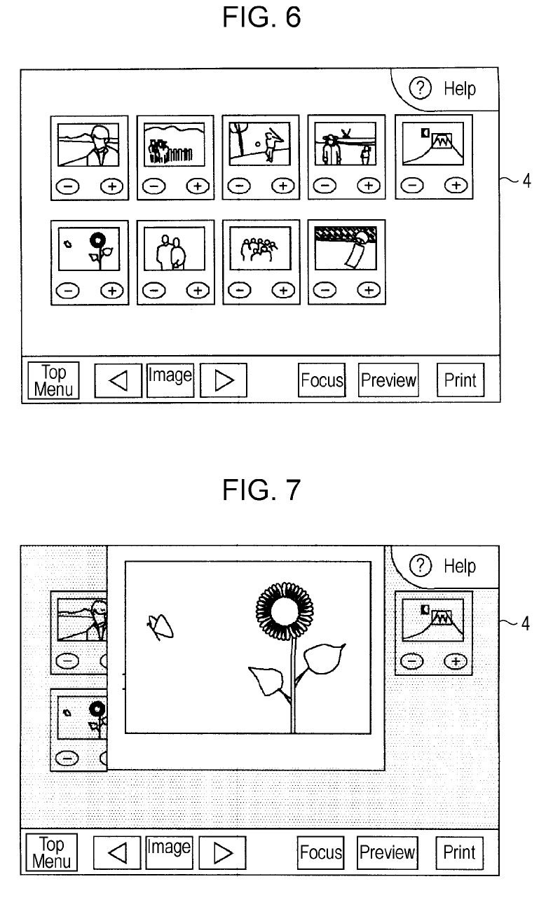

When selection of one of the menus displayed on the menu screen shown in FIG. 5 is detected, the CPU 11 switches the screen displayed on the image display section 4 and receives the selection by the user. This executes consecutive processing concerning each menu is executed. When, in the processing, selection of the menu “PRINTS” is detected, the CPU 11 displays the thumbnail list screen shown in FIG. 6.

The thumbnail list screen is used to display the still images recorded on the recording medium 16 in the form of a list of thumbnails. On the thumbnail list screen, for each thumbnail, the items “+” and “−” for setting the number of copies to be printed are displayed. At the bottom of the thumbnail list screen, the item “Print” for directing printing, the item “Preview” for directing display of a preview image, and the item “Focus” for directing display of a focus confirmation screen are displayed. In addition, page skipping keys for scrolling the thumbnail list screen, and the item “Top Menu” for directing display of the top menu screen are displayed. At the top of the thumbnail list screen, on the right side, the item “Help” for directing display of a help screen is displayed.

The CPU 11 uses the thumbnail list screen to receive settings on images to be printed and the number of copies to be printed, and the CPU 11 switches the screen displayed on the image display section 4 on the basis of an operation on the item “Print”, and receives a setting such as a print size. After that, the CPU 11 initiates printing on the basis of the received settings.

In a case where, when any thumbnail is selected, the item “Preview” is operated, as shown in FIG. 7, a preview image of the selected thumbnail is displayed as a sub-screen. The displayed preview image is all or part of an original image corresponding to the selected thumbnail.

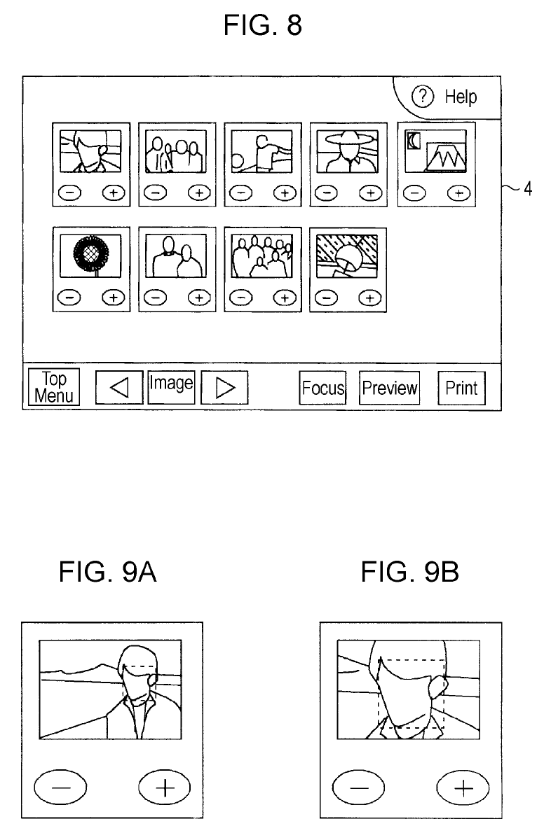

In a case where the item “Focus” is selected, the CPU 11 detects main portions from the individual still images, and displays a list of thumbnails replaced with the main portions, as shown in FIG. 8 in comparison with FIG. 6.

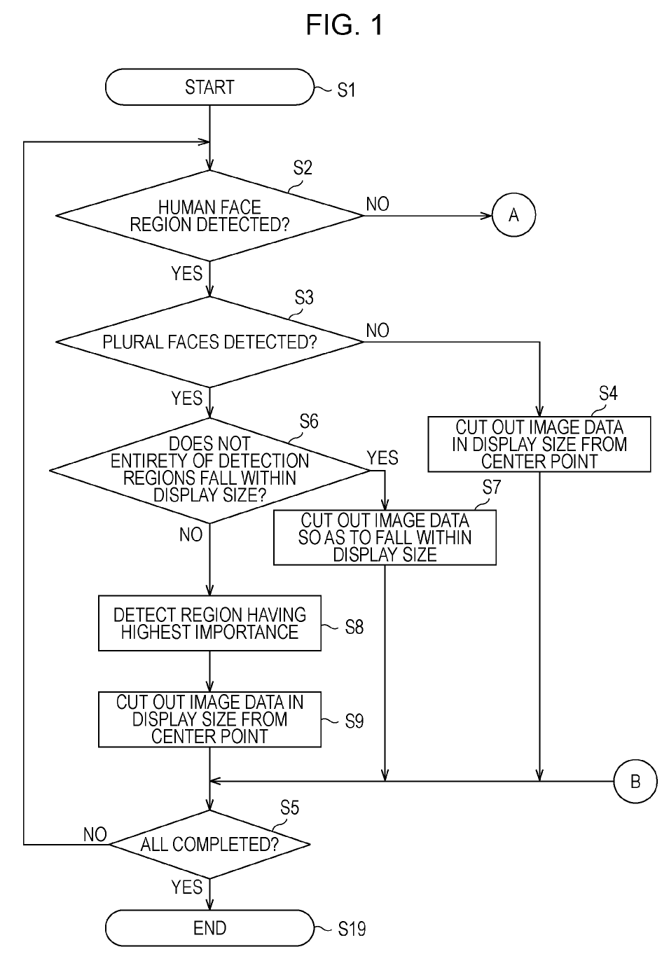

FIG. 1 is a flowchart illustrating a process of the CPU 11 concerning processing of the main portions. After starting this process, the CPU 11 proceeds from step S1 to S2. In step S2, the CPU 11 sets, as an image to be processed, one image displayed as a thumbnail, and obtains image data of the image to be processed from the recording medium 16. In addition, by applying a pattern matching technique to process the image data, the CPU 11 determines whether a human face region has been detected from the image to be processed. If the human face region has been detected, the CPU 11 proceeds to step S3, and determines whether a plurality of human faces have been detected.

If the result of the determination in step S3 is negative, as shown in FIG. 9A, the image to be processed is considered as an image obtained by photographing one person. The image to be processed is considered as an image obtained by focusing a face portion of the person, and the face portion is considered to be a main portion. The CPU 11 proceeds to step S4. As shown in FIG. 9B in comparison with FIG. 9A, the CPU 11 cuts out, from the center point of the region of the detected face, image data of a region corresponding to a display size of each thumbnail in the thumbnail list screen, and stores the cut-out image data in the memory 22. Proceeding to step S5, the CPU 11 determines whether all the still images displayed as thumbnails have been processed. If the result of the determination is negative, the CPU 11 returns to step S2. In FIG. 9A and the subsequent figures, each region in which a face has been detected is shown in a form in which it is rectangularly surrounded by dashed lines.

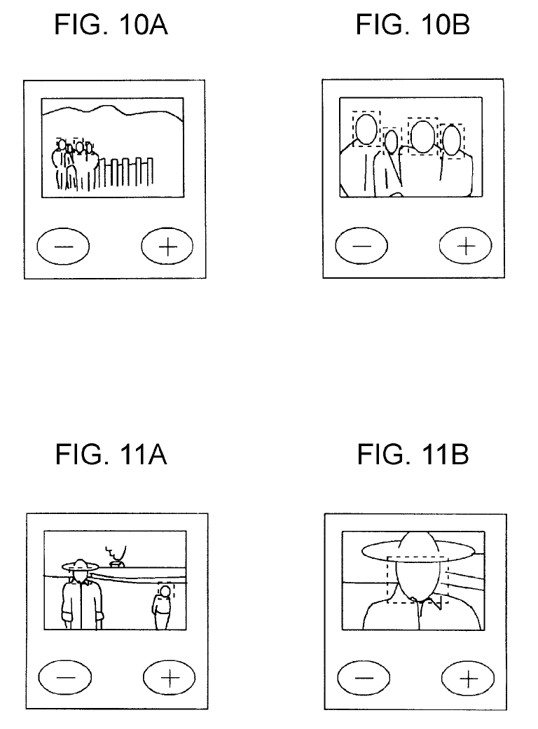

As shown in FIG. 10A, in a case where the image to be processed is a group photograph, a plurality of human faces are detected. In step S3, the CPU 11 determines affirmatively. In this case, proceeding from step S3 to S6, the CPU 11 determines the size of the entirety of regions in which the faces have been detected, and determines whether the size of the entirety of the regions does not fall within the display size of each thumbnail in the thumbnail list screen. If the CPU 11 has determined that the size of the entirety of the regions falls within the display size, the CPU 11 proceeds from step S6 to S7. As shown in FIG. 10B in comparison with FIG. 10A, similarly to step S4, the CPU 11 cuts out, from the center point of the entirety of the regions in which the faces have been detected, image data of a region corresponding to the display size of each thumbnail in the thumbnail list screen, and stores the cut-out image data in the memory 22. After that, the CPU 11 proceeds to step S5.

As shown in, for example, FIG. 11A, in a case where a plurality of persons are photographed and the persons are away from each other, in step S6, the CPU 11 determines that the size of the entirety of the regions does not fall within the display size of each thumbnail. In this case, the CPU 11 proceeds from step S6 to S8. In step S8, the CPU 11 selects a face having the highest importance from among the detected faces. In the first embodiment, a face that is detected as the largest face is selected as the face having the highest importance.

Next, proceeding to step S9, the CPU 11 processes a region of the selected face similarly to step S4. As shown in FIG. 11B in comparison with FIG. 11A, in this case, the face of the person in the foreground is cut out and its image data is stored in the memory 22. After that, the CPU 11 proceeds to step S5.

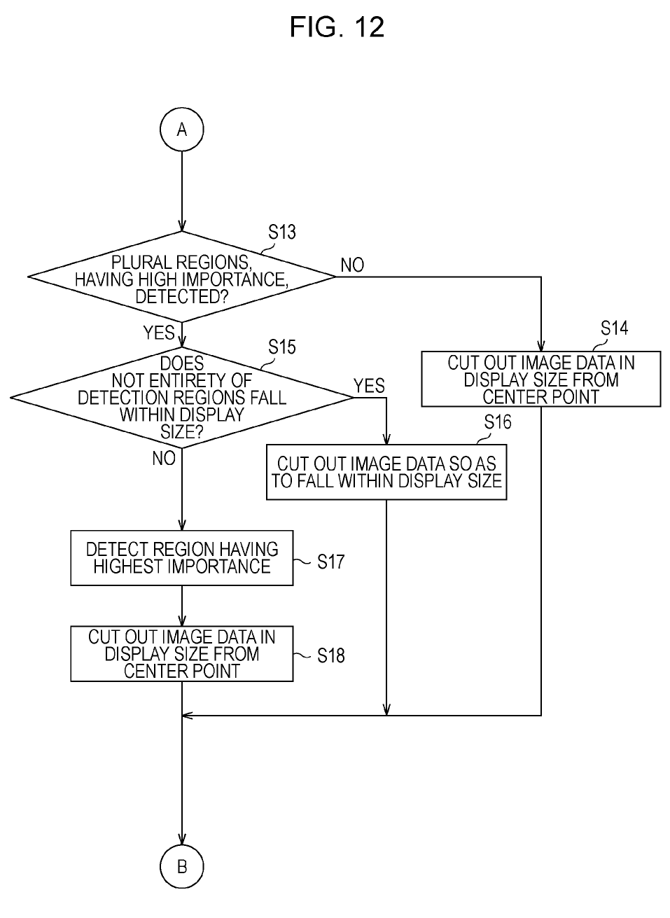

In a case where a scene or the like other than a person is photographed, in step S2, the CPU 11 is unable to detect a human face region. Thus, the CPU 11 proceeds from step S2 to S13 (see FIG. 12). Here, the CPU 11 detects parameters featuring portions of a still image, and processes the parameters to detect regions having high importance. The parameters include a region position, a shape, a luminance, a color, and an edge intensity. In the first embodiment, after dividing the still image into a plurality of regions and detecting such parameters for each region, by integrating the detected parameters for determination, each region having high importance is detected.

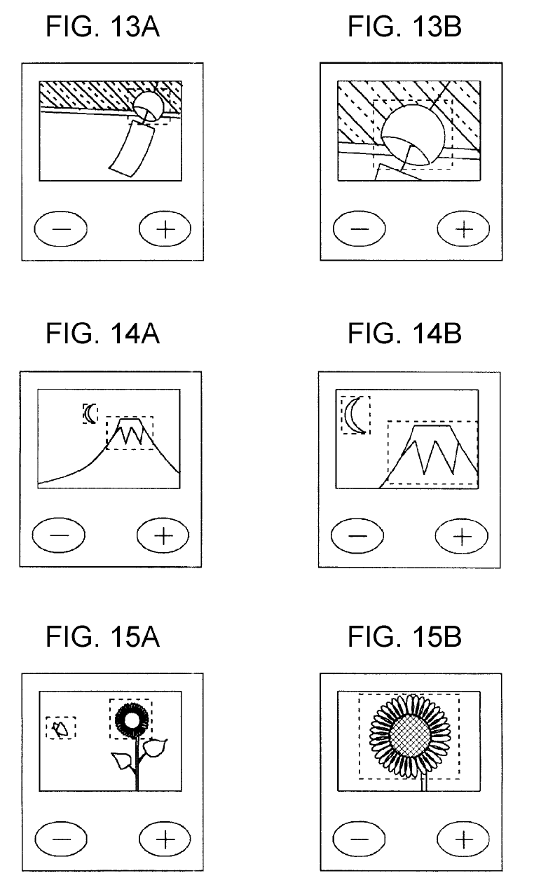

In step S13, the CPU 11 determines whether it has detected a plurality of regions having high importance. If, in step S13, the CPU 11 has determined negatively, the CPU 11 proceeds from step S13 to S14. As shown in FIGS. 13A and 13B, the CPU 11 cuts out, from the center point of a detected region having high importance, image data of a region corresponding to the display size of each thumbnail in the thumbnail list screen, and stores the cut-out image data in the memory 22. After that, the CPU 11 proceeds to step S5.

Conversely, as shown in FIG. 14A, when a plurality of regions having high importance are detected, the CPU 11 proceeds from step S13 to S15. In step S15, the CPU 11 determines whether the regions do not fall within the display size of each thumbnail in the thumbnail list screen. If the regions fall within the display size, the CPU 11 proceeds from step S15 to S16. As shown in FIG. 14B in comparison with FIG. 14A, similarly to step S4, the CPU 11 cuts out, from the center points of the regions, image data of each region corresponding to the display size of each thumbnail in the thumbnail list screen, and stores the cut-out image data in the memory 22. After that, the CPU 11 proceeds to step S5.

In a case where, in step S13, as shown in, for example, FIG. 15A, a plurality of regions having high importance are detected and are away from each other, in step S15, the CPU 11 determines that the regions do not fall within the display size. In this case, the CPU 11 proceeds from step S15 to S17. In step S17, the CPU 11 selects a region having the highest importance from among the detected regions. In the first embodiment, a region having a larger area is selected as the region having the highest importance.

Next, the CPU 11 proceeds to step S18 and processes the selected region similarly to step S4. As shown in FIG. 15B in comparison with FIG. 15A, in this example, the CPU 11 cuts out image data of the flower region, and stores the cut-out image data in the memory 22. After that, the CPU 11 proceeds to step S5.

After the CPU 11 completes the process for all the thumbnails in the thumbnail list screen, in step S5 (FIG. 1), the CPU 11 determines affirmatively. Proceeding from step S5 to S19, the CPU 11 finishes the process. In addition, the CPU 11 switches the thumbnail list screen to a thumbnail list screen based on the image data cut out and stored in the memory 22.

### Operations of First Embodiment

In the above-described configuration, with the image printing apparatus 1 (FIGS. 2 to 4), when the user loads the recording medium 16 such as a memory card and selects a print menu, still images recorded on the recording medium 16 are displayed in the form of a thumbnail list screen (FIG. 6). With the thumbnail list screen, images to be printed, a print size, and the number of copies to be printed are received. In addition, when the user directs printing, a set number of copies of each still image are sequentially printed in a set print size, and the printed copies are ejected from the ejection slot 2. This enables the user to easily print desired still images.

However, it is difficult to reliably confirm an image being out of focus in the case of using the thumbnail list screen. This causes a possibility that the still images are wastefully printed without noticing an image being out of focus.

Accordingly, with the image printing apparatus 1, when the user directs a preview in the thumbnail list screen, an original image corresponding to a user-selected thumbnail is displayed in an enlarged manner (FIG. 7). This enables detailed confirmation of an image being out of focus or the like, whereby unnecessary printing can be prevented.

However, in the case of confirming each image being out of focus by previewing the thumbnails one by one, a complicated operation needs to be performed. Accordingly, in the image printing apparatus 1, when focus confirmation is directed (FIGS. 1 and 7) on the thumbnail list screen, for each thumbnail of the thumbnail list screen, a main portion is detected. In addition, the main portion of each thumbnail is cut out from the original still image, and corresponding image data is stored in the memory 22. After that, the main portions are displayed in a list form instead of the thumbnails.

This enables the user to collectively confirm a plurality of still images displayed as a thumbnail list screen without directing previewing each thumbnail for confirmation, whereby each image being out of focus or the like can be easily and reliably confirmed.

Specifically, the image printing apparatus 1 initially detects a human face, sets, as a main portion, a region in which the human face has been detected, and displays the region. When a plurality of human faces are detected, the faces are displayed as main portions. When the faces exceed a display size, a face having the highest importance is selected and displayed. In addition, only if no human face is detected, by applying another technique, a region having high importance is detected and is set as a main portion.

In other words, most still images that are printed by image printing apparatus 1 are portraits in which persons are photographed. As in this first embodiment, when no human face is detected as the result of human face detection, by using another technique, a region having high importance is detected and set as a main portion, whereby unnecessary processing is effectively avoided and main portion detection can be efficiently performed.

In addition, even in a case where a region having high importance is detected and set as a main portion, if a plurality of regions having high importance are detected, the regions are displayed as main portions. If the regions exceed the display size, a region having the highest importance is selected and displayed. Accordingly, with the image printing apparatus 1, a user-desired portion can be reliably set as a main portion and can be confirmed.

### Advantages of First Embodiment

According to the above-described configuration, by detecting and displaying a main portion of a still image, an image being out of focus or the like can be easily and reliably confirmed.

By displaying main portions in the form of a list, a plurality of still images can be collectively checked for an image being out of focus or the like, and usability can be improved.

In addition, by switching between a main portion list screen and a thumbnail list screen, a plurality of still images can be checked for details, while confirming the entirety of each still image. This can also improve usability.

### Second Embodiment

In a second embodiment of the present invention, by applying the present invention to an image pickup apparatus, from captured still images, main portions are detected and displayed in response to a user's operation for confirmation in the case of recording the still images on the recording medium 16. In addition, by displaying a plurality of still images temporarily recorded on the recording medium 16 in the form of a list, the present invention may be applied to the case of selecting still images to be deleted.

According to the second embodiment, by applying the present invention to an image pickup apparatus, unnecessary image pickup results can be prevented from being recorded in such a manner that an image being out of focus or the like is easily and reliably confirmed.

### Third Embodiment

The first embodiment describes the case of switching between a thumbnail list screen and a main portion list screen. However, the present invention is not limited to the case. Also in the case of displaying a preview, a main portion is detected from the preview, and the preview may be partially displayed. Further, in cases such as when an image to be displayed is selected with a file name, a main portion of the image may be directly displayed.

In addition, the first embodiment describes a case in which the present invention is applied to an image printing apparatus. However, the present invention is not limited to the case. The present invention can be widely applied to printing software for personal computers, etc.

It should be understood by those skilled in the art that various modifications, combinations, sub-combinations and alterations may occur depending on design requirements and other factors insofar as they are within the scope of the appended claims or the equivalents thereof.

What is claimed is:

1. An image display apparatus comprising:
main portion detecting means for performing detection of a main portion of at least one still image from the still image;
cutout means for cutting out the main portion from the still image on the basis of a result of the detection by the main portion detecting means; and
display means for displaying at least one main portion image based on the main portion cut out by the cutout means.

2. The image display apparatus according to claim 1,
wherein the at least one still image includes a plurality of still images, and the at least one main portion image includes a plurality of main portion images, and
wherein the display means displays the plurality of main portion images in the form of a list on the basis of the plurality of still images.

3. The image display apparatus according to claim 1,
wherein the display means switches the displayed main portion image to a displayed corresponding thumbnail of the still image in response to a user's operation.

4. The image display apparatus according to claim 2, further comprising printing means for printing at least one still image that is selected from among the plurality of still images by selecting at least one of the plurality of main portion images displayed in the form of the list, and
wherein the plurality of still images are recorded on a recording medium.

5. The image display apparatus according to claim 1, further comprising recording means for recording the still image on a recording medium in response to a user's operation,
wherein the still image is acquired by image pickup means integrated with the image display apparatus.

6. The image display apparatus according to claim 1,
wherein the main portion is a human face.

7. An image display method for displaying at least one still image, comprising the steps of:
performing detection of a main portion of the still image from the still image;
cutting out the main portion from the still image on the basis of a result of the detection; and
displaying at least one main portion image based on the
cut-out main portion.

8. A recording medium containing a program of an image display method for displaying at least one still image, the image display method comprising the steps of:
performing detection of a main portion of the still image from the still image;
cutting out the main portion from the still image on the basis of a result of the detection; and
displaying at least one main portion image based on the cut-out main portion.

9. An image display apparatus comprising:
a main portion detecting unit configured to perform detection of a main portion of at least one still image from the still image;
a cutout unit configured to cut out the main portion from the still image on the basis of a result of the detection by the main portion detecting unit; and
a display unit configured to display at least one main portion image based on the main portion cut out by the cutout unit.
